(19) United States
(12) Patent Application Publication
(10) Pub. No.: US 2016/0326950 A1
(43) Pub. Date: Nov. 10, 2016

(54) SUPPORT ASSEMBLIES FOR AIR-TO-AIR AFTERCOOLER

(71) Applicant: Caterpillar Inc., Peoria, IL (US)

(72) Inventors: Joseph L. Kennedy, Peoria, IL (US); Sudhakara R. Gopireddy, Dunlap, IL (US); James M. Voelker, Metamora, IL (US); Nirag Sheth, Peoria, IL (US)

(73) Assignee: Caterpillar Inc., Peoria, IL (US)

(21) Appl. No.: 15/214,169

(22) Filed: Jul. 19, 2016

(51) Int. Cl. F02B 29/04

(52) U.S. Cl. CPC F02B 29/0456; F02B 29/0425

(57) ABSTRACT

Support assembly for installation of a first core and a second core on a frame of an air-to-air aftercooler (ATAAC) is provided. The first core includes a first fluid connection portion. The second core includes a second fluid connection portion. Each support assembly includes a first attachment member, a second attachment member, and a spacer member. The first attachment member removably attaches to the first fluid connection portion. The second attachment member is positioned parallel to the first attachment member and removably attaches to the second fluid connection portion. The spacer member is perpendicularly positioned between and maintains a predetermined distance between the first attachment member and the second attachment member. Therefore, the support assembly axially aligns the first fluid connection portion and the second fluid connection portion during installation of the frame on the first core and the second core of the aftercooler.

### TECHNICAL FIELD

The present disclosure relates generally to one or more support assemblies for an air-to-air aftercooler (ATAAC). More specifically, the present disclosure relates to the one or more support assemblies for installing a frame on multiple cores of the ATAAC.

### BACKGROUND

Engines, such as internal combustion engines, employ an air intake system to supply compressed air to an intake manifold of an internal combustion engine. The air intake system generally employs a turbocharger and an air-to-air aftercooler (ATAAC). The turbocharger is adapted to compress the air prior to supplying to the intake manifold of the engine. However, compressing the air may cause an increase in the temperature of the air. The ATAAC is positioned downstream of the turbocharger. The ATAAC is adapted to cool the air before supplying to the intake manifold of the internal combustion engine.

For efficient cooling of the air, the ATAAC may employ two cores, namely a first core and a second core installed within a frame. A portion of the air is cooled in the first core, while the remaining portion of the air is cooled in the second core of the aftercooler. Moreover, the first core includes an inlet port and an outlet port of the ATAAC. In order to supply a portion of the air to the second core and return the portion of the air from the second core, the first core is required to be in fluid communication with the second core of the aftercooler. In conventional ATAACs, the first core is fluidly connected to the second core via one or more fluid attachment assemblies. Examples of the fluid attachment assemblies may include, but is not limited to, a bellow, a hump hose, and a flex pipe.

During assembly of the ATAAC, the frame is installed on the first core and the second core of the ATAAC while the fluid attachment assemblies are positioned between the first core and the second core. More specifically, the frame is tightened on the first core and the second core of the ATAAC. Sometimes, during such installation of the frame on the first core and the second core, an axial misalignment may be observed between the first core and the second core of the ATAAC.

However, in known solutions, the axial misalignment between the first core and the second core may reach beyond the acceptable limits of the fluid attachment assemblies. This may induce unwanted stresses in the fluid attachment assemblies between the first core and the second core. The unwanted stresses on the fluid attachment assemblies may lead to relatively loose fluid connection between the first core and the second core. Therefore, such assembly of various components of the ATAAC may require additional operator effort and may result in an increased overall assembling cost of the ATAAC. Hence, there is a need to provide an improved system that facilitates relatively easy assembly of the ATAAC.

### SUMMARY OF THE DISCLOSURE

Various aspects of the present disclosure are directed towards a support assembly for installation of a frame on a first core and a second core of an aftercooler. The first core includes a first fluid connection portion. The second core includes a second fluid connection portion. The support assembly includes a first attachment member, a second attachment member, and a spacer member. The first attachment member is adapted to be removably attached to the first fluid connection portion of the first core. The second attachment member is adapted to be removably attached to the second fluid connection portion of the second core. The second attachment member is positioned parallel to the first attachment member. The spacer member is perpendicularly positioned between the first attachment member and the second attachment member. The spacer member is adapted to maintain a predetermined distance between the first attachment member and the second attachment member. Therefore, the support assembly axially aligns the first fluid connection portion of the first core and the second fluid connection portion of the second core during the installation of the frame on the first core and the second core of the aftercooler.

### BRIEF DESCRIPTION OF THE DRAWINGS

FIG. 1 is a block diagram of an engine, illustrating a turbocharger and an air-to-air after cooler (ATAAC) of an air intake system of the engine, in accordance with the concepts of the present disclosure;

FIG. 2 is a side view of the (ATAAC) of FIG. 1, illustrating one or more support assemblies positioned between a first core and a second core of the ATAAC, in accordance with the concepts of the present disclosure;

FIG. 3 is a perspective view of a first support member of FIG. 2, in accordance with the concepts of the present disclosure;

FIG. 4 is a perspective view of a second support member of FIG. 2, in accordance with the concepts of the present disclosure; and

FIG. 5 is a flow chart of a method of assembling the ATAAC, in accordance with the concepts of the present disclosure.

### DETAILED DESCRIPTION

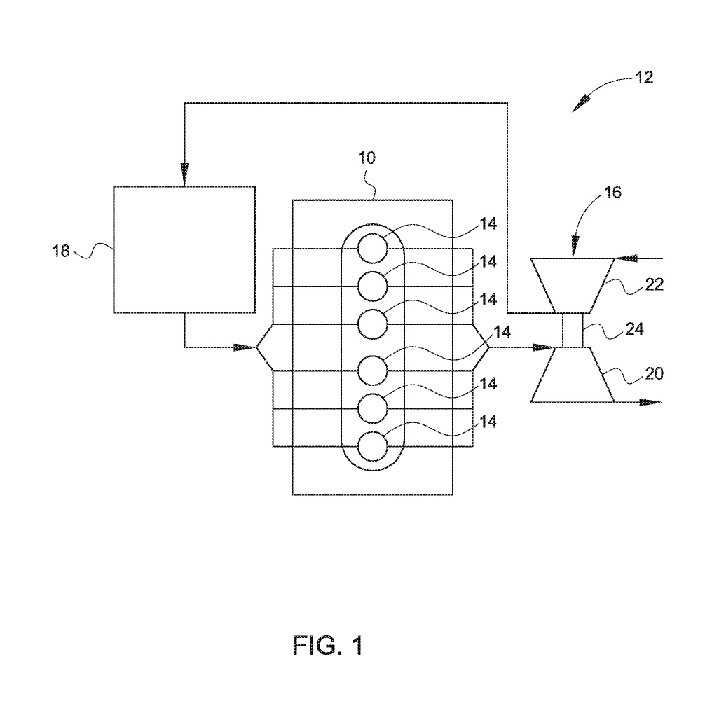

Referring to FIG. 1, a block diagram of an engine 10 employing an air intake system 12 is shown. The engine 10 may be an inline internal combustion engine that includes six combustion cylinders 14. Each of the six combustion cylinders 14 are adapted to receive compressed air from the air intake system 12 in order to generate engine power. More specifically, each of the six combustion cylinders 14 mixes fuel with the compressed air and combusts the air-fuel mixture, in order to generate engine power. Although, the present disclosure describes six combustion cylinders 14, a varied number of the combustion cylinders 14 may be contemplated. Additionally, although, concepts of the present disclosure are described as applied to the engine 10 with the combustion cylinders 14 arranged in an in-line configuration, applicability to the engines with the combustion cylinders arranged in various other configuration may also be contemplated. For example, applicability to the engine with the combustion cylinders arranged in a V configuration may also be contemplated.

The air intake system 12 is employed to supply the compressed air to the combustion cylinders 14 of the engine 10. The air intake system 12 includes a turbocharger 16 and an air-to-air aftercooler 18. The turbocharger 16 is a combination of a turbine 20 and a compressor 22. The turbine 20 is fluidly connected to the combustion cylinders 14 via an exhaust manifold (not shown). The turbine 20 is adapted to receive exhaust gases from the combustion cylinders 14 for turbine operation. More specifically, the exhaust gases drive the turbine 20 of the turbocharger 16. Thereafter, the exhaust gases are vented to external environment. The compressor 22 is mechanically coupled to and is driven by the turbine 20 via a shaft arrangement 24. The compressor 22 is fluidly disposed between an air source (not shown) and the ATAAC 18. When driven by the turbine 20, the compressor 22 receives air from the air source (not shown), compresses the air, and supplies the compressed air to the ATAAC 18.

The ATAAC 18 is fluidly disposed between the compressor 22 and the combustion cylinders 14 of the engine 10. The ATAAC 18 is adapted to receive the compressed air from the compressor 22, cool the compressed air, and supply the cooled and compressed air to the combustion cylinders 14 for efficient power generation. Although, concepts of the present disclosure are described as applied to the air-to-air aftercooler 18, applicability to various other types of aftercoolers may also be contemplated. A structure and arrangement of the ATAAC 18 will further be described in detail hereinafter.

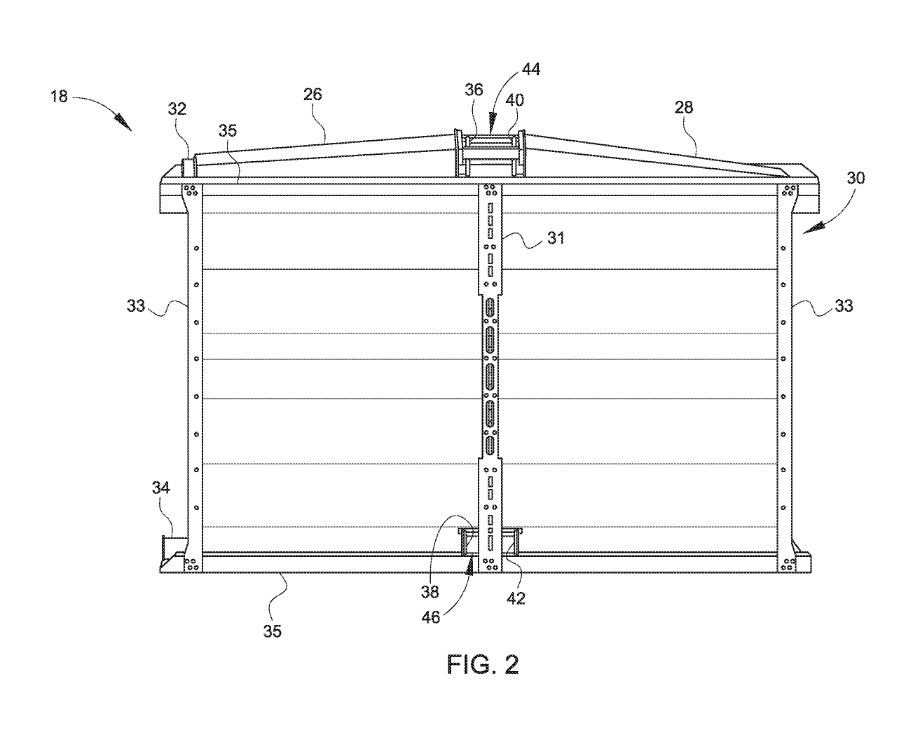

Referring to FIG. 2, there is shown the ATAAC 18 of the air intake system 12. The ATAAC 18 includes a first core 26, a second core 28, and a frame 30. The frame 30 is a combination of one central plate 31, two side plates 33, and two horizontal plates 35, installed on each side of the ATAAC 18. The frame 30 is installed on each of the first core 26 and the second core 28 of the ATAAC 18. The ATAAC 18 is capable of being mounted on the engine 10 by installing the frame 30 to one or more components (not shown) of the engine 10. Although, concepts of the present disclosure are described as applied to the ATAAC 18 employing two cores 26, 28, applicability to the ATAACs employing a varied number of cores may also be contemplated. For example, applicability to a similar ATAAC employing four cores, with two of the four cores in fluid communication with each other, may also be contemplated.

Further, the first core 26 and the second core 28 of the ATAAC 18 in conjunction are adapted to cool the compressed air received from the compressor 22 (see FIG. 1) of the turbocharger 16 (see FIG. 1). More specifically, a portion of the compressed air is cooled in the second core 28, while remaining of the compressed air is cooled in the first core 26 of the ATAAC 18. Each of the first core 26 and the second core 28 of the ATAAC 18 includes one or more cooling tubes (not shown) suitably bent to facilitate cooling of the inflowing air. More specifically, the one or more first cooling tubes (not shown) of each of the first core 26 and the second core 28 extract heat from the inflowing air and dissipate to surrounding air in external environment, by way of convection.

The first core 26 of the ATAAC 18 includes an inlet port 32, an outlet port 34, one or more first cooling tubes (not shown), a first fluid connection portion 36, and a third fluid connection portion 38. The inlet port 32 is fluidly connected to the compressor 22 (see FIG. 1) and is adapted to receive all the compressed air from the compressor 22 (see FIG. 1). The outlet port 34 is fluidly connected to the combustion cylinders 14 and is adapted to supply the cooled and compressed air to the combustion cylinders 14 of the engine 10. The one or more first cooling tubes (not shown) of the first core 26 are suitably bent and fluidly disposed between the inlet port 32 and the outlet port 34 to cool the air flowing through the first core 26. Moreover, the first fluid connection portion 36 of the ATAAC 18 is in fluid communication with the inlet port 32 of the first core 26. In order to supply the portion of the air to the second core 28, the first fluid connection portion 36 of the first core 26 is in fluid communication with the second core 28. Also, the third fluid connection portion 38 is in fluid communication with the outlet port 34 of the first core 26. In order to receive the cooled air from the second core 28, the third fluid connection portion 38 of the first core 26 is in fluid communication with the second core 28.

The second core 28 of the ATAAC 18 includes a second fluid connection portion 40, a fourth fluid connection portion 42, and one or more second cooling tubes (not shown). The second fluid connection portion 40 of the second core 28 is fluidly connected to the first fluid connection portion 36 of the first core 26 via a fluid attachment assembly (not shown). Therefore, the second core 28 receives the portion of the air from the first core 26 for cooling. Moreover, the fourth fluid connection portion 42 of the second core 28 is fluidly connected to the third fluid connection portion 38 of the first core 26 via another fluid attachment assembly (not shown). Therefore, the second core 28 supplies the portion of the air to the first core 26 after cooling. The one or more second cooling tubes (not shown) of the second core 28 are suitably bent and fluidly disposed between the first fluid connection portion 36 and the second fluid connection portion 40, to cool the air flowing through the second core 28. For the purpose of clear understanding, the ATAAC 18 is shown with the fluid attachment assemblies (not shown) are uninstalled from the ATAAC 18.

Furthermore, the first core 26, the second core 28, and the frame 30 are assembled with each other, in order to form aforementioned structure of the ATAAC 18. During such assembly of the ATAAC 18, one or more support assemblies 44, 46 are employed. More specifically, the one or more support assemblies 44, 46 are employed during installation of the frame 30 on the first core 26 and the second core 28 of the ATAAC 18. In the current embodiment, the ATAAC 18 employs two support assemblies 44, 46, namely a first support assembly 44 and a second support assembly 46. The first support assembly 44 is positioned between the first fluid connection portion 36 of the first core 26 and the second fluid connection portion 40 of the second core 28, during installation of the frame 30 on the first core 26 and the second core 28 of the ATAAC 18. Additionally, the second support assembly 46 is positioned between the third fluid connection portion 38 of the first core 26 and the fourth fluid connection portion 42 of the second core 28, during installation of the frame 30 on the first core 26 and the second core 28 of the ATAAC 18.

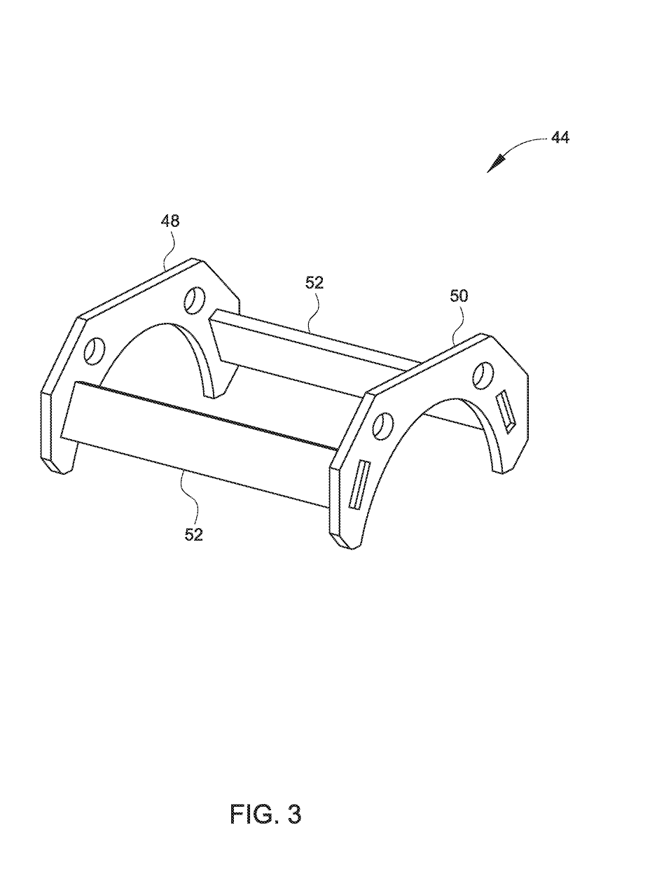

Referring to FIG. 3, the first support assembly 44 is shown, in accordance with the concepts of the present disclosure. The first support assembly 44 includes a first attachment member 48, a second attachment member 50, and two spacer members 52. The second attachment member 50 is parallel to the first attachment member 48. The first attachment member 48 and the second attachment member 50 of the first support assembly 44 are suitably structured to be removably attached to the first fluid connection portion 36 and the second fluid connection portion 40 respectively. The first attachment member 48 of the first support assembly 44 is structured to be removably attached to the first fluid connection portion 36 of the first core 26. The second attachment member 50 of the first support assembly 44 is structured to be removably attached to the second fluid connection portion 40 of the second core 28. A number of fasteners (not shown) may be employed to removably attach the first attachment member 48 to the first fluid connection portion 36 and to removably attach the second attachment member 50 to the second fluid connection portion 40. The spacer members 52 are disposed perpendicularly between the first attachment member 48 and the second attachment member 50 of the first support assembly 44. The spacer members 52 maintain a predetermined distance between the first attachment member 48 and the second attachment member 50 of the first support assembly 44. Therefore, the first support assembly 44 axially aligns the first fluid connection portion 36 and the second fluid connection portion 40, during installation of the frame 30 on the first core 26 and the second core 28 of the ATAAC 18.

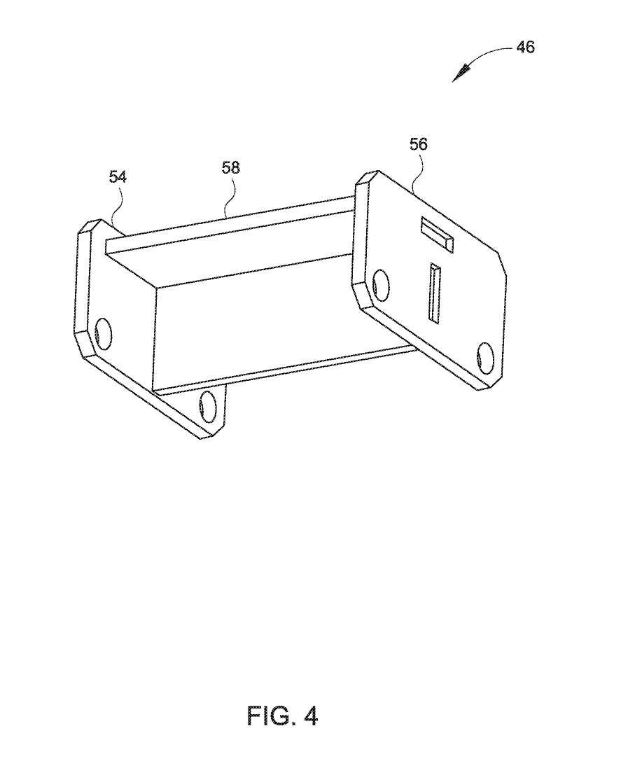

Referring to FIG. 4, the second support assembly 46 is shown, in accordance with the concepts of the present disclosure. Similar to the first support assembly 44, the second support assembly 46 includes a first attachment member 54, a second attachment member 56, and a spacer member 58. The second attachment member 56 is disposed parallel to the first attachment member 54. The first attachment member 54 and the second attachment member 56 of the second support assembly 46 are suitably structured to be removably attached to the third fluid connection portion 38 and the fourth fluid connection portion 42 respectively.

More specifically, the first attachment member 54 of the second support assembly 46 is suitably structured to be removably attached to the third fluid connection portion 38 of the first core 26. The second attachment member 56 of the second support assembly 46 is suitably structured to be removably attached to the fourth fluid connection portion 42 of the second core 28. A number of fasteners (not shown) may be employed to attach the first attachment member 54 with the third fluid connection portion 38 and to attach the second attachment member 56 with the fourth fluid connection portion 42. The spacer member 58 is disposed perpendicular between the first attachment member 54 and the second attachment member 56 of the second support assembly 46. The spacer member 58 maintains a predetermined distance between the first attachment member 54 and the second attachment member 56 of the second support assembly 46. Therefore, the second support assembly 46 axially aligns the third fluid connection portion 38 and the fourth fluid connection portion 42 during installation of the frame 30 on the first core 26 and the second core 28 of the ATAAC 18.

A person of ordinary skill in the art will appreciate that the design and structure of the support assemblies 44, 46 provided herein are exemplary and vary based on system requirements. The support assemblies 44, 46 may include additional structural components to removably affix the support assemblies 44, 46 to the first core 26 and the second core 28 of the ATAAC 18, and is structured to maintain the axial alignment between the first core 26 and the second core 28 for further installation of the frame 30 and other fluid attachment assemblies, for example, bellows and hump hoses.

### INDUSTRIAL APPLICABILITY

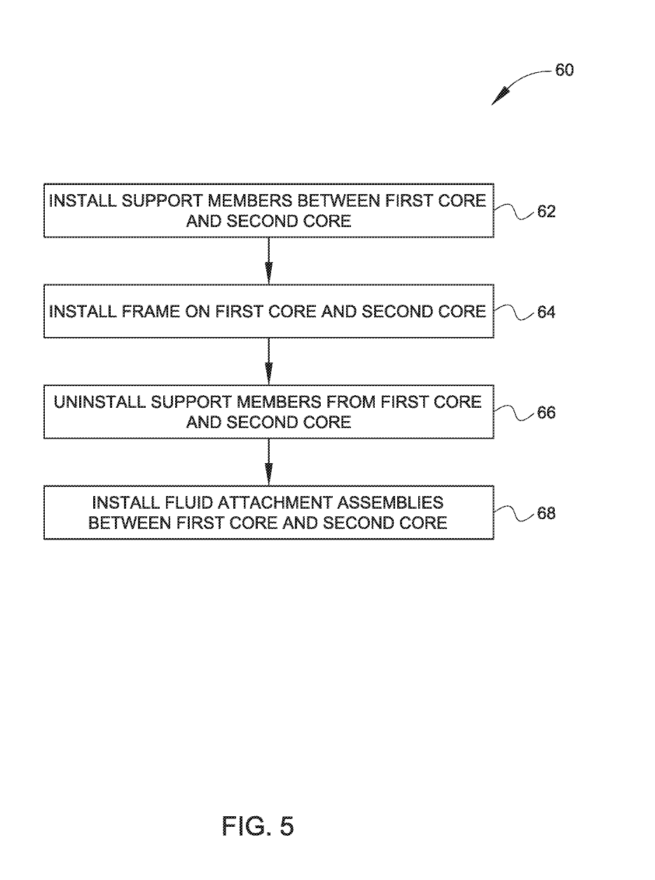

Referring to FIG. 5, there is shown a flowchart of a method 60 of assembling the ATAAC 18, in accordance with the concepts of the present disclosure. More specifically, the method 60 describes various steps of installing the first core 26 and the second core 28 on the frame 30 of the ATAAC 18. The method 60 initiates at step 62.

At step 62, the first support assembly 44 and the second support assembly 46 are installed between the first core 26 and the second core 28. More specifically, an operator installs the first support assembly 44 between the first fluid connection portion 36 of the first core 26 and the second fluid connection portion 40 of the second core 28. A number of fasteners (not shown) may be employed to install the first support assembly 44 between first fluid connection portion 36 of the first core 26 and the second fluid connection portion 40 of the second core 28. The first support assembly 44 axially aligns the first fluid connection portion 36 of the first core 26 with the second fluid connection portion 40 of the second core 28. Additionally, the operator installs the second support assembly 46 between the third fluid connection portion 38 of the first core 26 and the fourth fluid connection portion 42 of the second core 28. A number of fasteners (not shown) may be employed to install the second support assembly 46 between the third fluid connection portion 38 of the first core 26 and the fourth fluid connection portion 42 of the second core 28. The second support assembly 46 axially aligns the third fluid connection portion 38 of the first core 26 with the fourth fluid connection portion 42 of the second core 28.

At step 64, the frame 30 is installed on the first core 26 and the second core 28 of the ATAAC 18. More specifically, one central plate 31, two side plates 33, and two horizontal plates 35 of the frame 30 are installed on each side of the assembly of the first core 26 and the second core 28 of the ATAAC 18. A number of additional fasteners (not shown) may be employed to install the central plate 31, the side plates 33, and the horizontal plates 35 on the assembly of the first core 26 and the second core 28 of the ATAAC 18. While the frame 30 is installed on the assembly between the first core 26 and the second core 28, the first support assembly 44 and the second support assembly 46 axially aligns the first core 26 and the second core 28.

At step 66, the first support assembly 44 and the second support assembly 46 are uninstalled from each of the first core 26 and the second core 28 of the ATAAC 18. More specifically, the fasteners (not shown) that are used to install the first support assembly 44 and the second support assembly 46 on the first core 26 and the second core 28, are unscrewed. Therefore, the first support assembly 44 and the second support assembly 46 are uninstalled.

At step 68, the fluid attachment assemblies (not shown) are installed between the first core 26 and the second core 28, to facilitate a fluid communication between the first core 26 and the second core 28 of the ATAAC 18. In an embodiment, a bellow (not shown) is installed between the first fluid connection portion 36 of the first core 26 and the second fluid connection portion 40 of the second core 28. The bellow facilitates a fluid communication between the first fluid connection portion 36 and the second fluid connection portion 40. Moreover, a hump hose (not shown) is installed between the third fluid connection portion 38 of the first core 26 and the fourth fluid connection portion 42 of the second core 28. The hump hose facilitates a fluid communication between the third fluid connection portion 38 and the fourth fluid connection portion 42.

During installation of the bellow and the hump hose, the first core 26 is axially aligned relative to the second core 28. Therefore, the bellow and the hump hose are relatively easily installed between the first core 26 and the second core 28 of the ATAAC 18. Additionally, negligible stress may be observed in the bellow and the hump hose during normal operation.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claim(s) and any equivalents thereof

What is claimed is:

1. A support assembly for installation of a frame on a first core and a second core of an aftercooler, the first core including a first fluid connection portion, the second core including a second fluid connection portion, the support assembly comprising:
a first attachment member adapted to be removably attached to the first fluid connection portion of the first core; and
a second attachment member adapted to be removably attached to the second fluid connection portion of the second core, wherein the second attachment member is positioned parallel to the first attachment member; and
a spacer member perpendicularly positioned between the first attachment member and the second attachment member, wherein the spacer member is adapted to maintain a predetermined distance between the first attachment member and the second attachment member, such that the support assembly is adapted to axially align the first fluid connection portion of the first core and the second fluid connection portion of the second core during the installation of the frame on the first core and the second core of the aftercooler.
